(19) United States
(12) Patent Application Publication
(10) Pub. No.: US 2002/0072953 A1
(43) Pub. Date: Jun. 13, 2002

(54) Process, a method, a system and software architecture for evaluating supplier performance

(76) Inventors: Eric S. Michlowitz, Austin, TX (US); Elisa J. Sumner, Austin, TX (US)

Correspondence Address: Stephen A. Terrile, SKJERVEN MORRILL MacPHERSON LLP, Suite 700, 25 Metro Drive, San Jose, CA, 95110-1349, US

(21) Appl. No.: 09/733,190

(22) Filed: Dec. 8, 2000

(51) Int. Cl. G06F 17/60

(52) U.S. Cl. 705/10

(57) ABSTRACT

According to the present invention, a method, a system and software architecture are disclosed for evaluating a manufacturer's suppliers. The invention teaches a method for electronically compiling analysis of a supplier's performance from team members, the supplier and a team leader. The invention discloses several measures of efficiency of each supplier and further discloses reports to compare suppliers to other suppliers of the same, or similar, components. Additional reports can be generated to show historical trend of the supplier's performance.

An embodiment of the invention allows suppliers to review their final scorecards and compare their score cards to other suppliers of the same, or similar, components. An embodiment of the invention allows to observe their scorecards and to compare their score cards with other suppliers of similar material. Finally an embodiment of the invention discloses a method allowing a manufacturer to compare suppliers providing the same or similar components.

### BACKGROUND OF THE INVENTION

1. Field of the Invention

This invention relates generally to a system and method for evaluation of supplier performance.

2. Description of the Related Art

It is known that manufacturers assemble finished products from materials supplied by suppliers and other vendors. Suppliers may include manufacturers which manufacture a component from raw materials, assemblers who assemble a component from purchased sub-components, vendors and service providers. In some cases a supplier may be both a manufacturer and assembler. (Hereinafter “manufacturer” refers to a manufacturer of a product for sale to a consumer and “supplier” refers to vendors and assemblers.) An extensive network of suppliers has developed to meet the need of the electronics manufacturing industry.

Competition between suppliers produces costs savings to the manufacturer and hence to the consumer. Competition between suppliers also facilitates product design and improvements. Early identification of unreliable or under-performing components creates the opportunity for a supplier to improve a product leading to more reliable and technically advanced computer systems.

Computer manufacturers rate or evaluate suppliers to facilitate supplier performance. Rating a supplier allows a manufacturer to determine the value, effectiveness and efficiency of specific suppliers as compared to other available suppliers. A manufacturer may set a performance goal for a supplier and rate the supplier to determine of the supplier met the goal. A manufacturer may identify a deficiency which needs to be corrected. In addition (or alternatively) a manufacturer may identify a supplier's strength and encourage competing suppliers to match a performance measure.

Measuring a supplier's performance requires a large amount of time and resources. A need exists for an efficient process to objectively measure a supplier's performance.

### SUMMARY OF THE INVENTION

According to the present invention, a method, a system and software architecture are disclosed for evaluating a manufacturer's suppliers. The invention teaches a method for electronically compiling analysis of a supplier's performance from team members, the supplier and a team leader. The invention discloses several measures of efficiency of each supplier and further discloses reports to compare suppliers to other suppliers of the same, or similar, components. Additional reports can be generated to show historical trend of the supplier's performance. An embodiment of the invention allows suppliers to review their final scorecards and compare their score cards to other suppliers of the same, or similar, components. An embodiment of the invention allows to observe their scorecards and to compare their score cards with other suppliers of similar material.

Features of the invention provide an opportunity for a manufacturer to produce a higher quality product at a lower cost. Features of the invention allow efficient gathering of comments and supplier evaluations from various individuals within the manufacturer's organization. Finally, certain features of the invention allow a manufacturer to compare suppliers providing similar or equivalent components.

The foregoing is a summary and this contains, by necessity, simplifications, generalizations and omissions of detail; consequently, those skilled in the art will appreciate that the summary is illustrative only and is not intended to be in any way limiting.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 shows a block diagram of a computer system suitable for implementing embodiments of the present invention.

FIG. 2 shows a block diagram of the interconnection of a computer system to a network environment in which the present invention may be practiced.

FIG. 3 shows a block diagram of the logical connection between various participants in the process including the team lead, team member, executives and the supplier.

FIG. 4 shows the logical relationship between individual tables for storage of data. FIG. 4A shows the specific tables relating to individual, final and self-evaluation scores. FIG. 4B shows the tables storing information related to scorecard templates. FIG. 4C shows user maintenance tables. FIG. 4D shows reference tables provide a supplier access to manufacturing information.

FIG. 5 shows a plan view of a web page used by a team member to record the team members input to the supplier's performances.

FIG. 6 shows a plan view of a web page used by a supplier to facilitate entering self-evaluation scores.

FIG. 7 shows a plan view of a web page used by a team leader to review and revise final scores.

FIG. 8 shows a plan view of a web page which facilitates a team leader's review of a team member's comments.

FIG. 9 shows a plan view of a web page which facilitates agreement by representatives of a manufacturer and a supplier to improve the supplier's scores.

FIG. 10 shows a plan view of a web page which facilitates viewing reports on a supplier's performance, a suppliers performance for all commodities supplied to the manufacturer and reports on all suppliers of a specific commodity.

FIG. 11 shows a plan view of a web page depicting a supplier's share of the total available market.

### DETAILED DESCRIPTION

The following is intended to provide a detailed description of an example of the invention and should not be taken to be limiting of the invention itself. Rather, any number of variations may fall within the scope of the invention which is defined in the claims following the description. An example of an environment in which the invention may operate is the manufacture of a computer system. However, this disclosure should not be taken to be limiting, the invention may equally be used to evaluate a supplier to manufacturers of computer systems and other products.

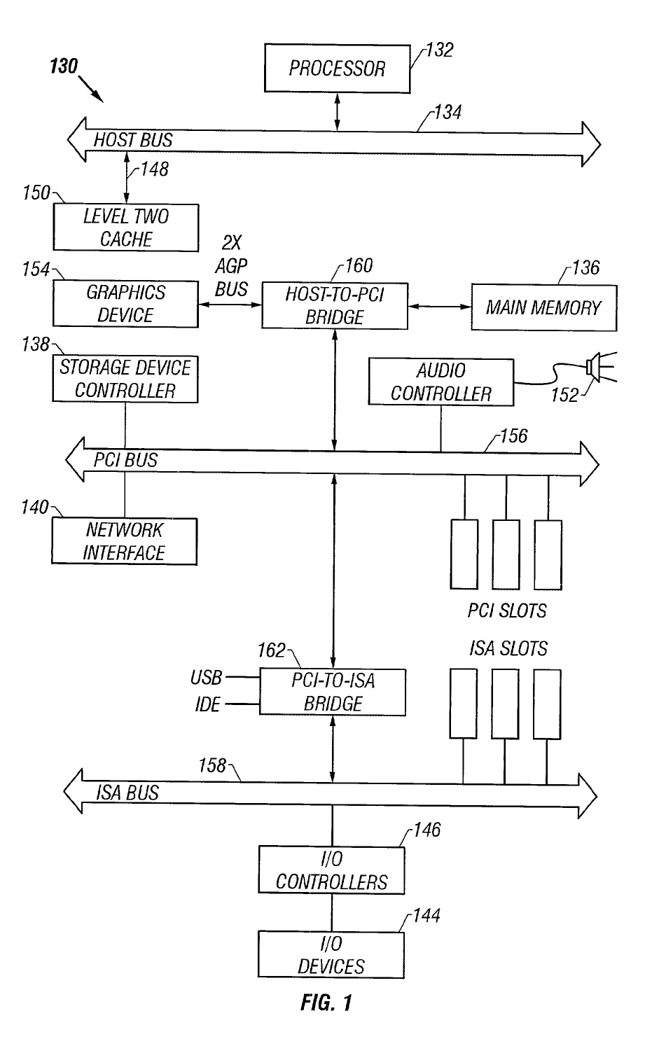

FIG. 1 is a block diagram of an exemplary computer system 130 that may be found in many forms. FIG. 1 is intended to be illustrative of a computer system and should not be taken to be limiting. Computer system 130 includes central processing unit (CPU) 132 connected by host bus 134 to various components including main memory 136, storage device controller 138, network interface 140, audio and video controllers 142, and input/output devices 144 connected via input/output (I/O) controllers 146. Heat sink 164 is located adjacent to CPU 132 as shown. Those skilled in the art will appreciate that this system encompasses all types of computer systems including, for example, mainframes, minicomputers, workstations, servers, personal computers, Internet terminals, network appliances, notebooks, palm tops, personal digital assistants, and embedded systems.

Typically computer system 130 also includes cache memory 150 to facilitate quicker access between processor 132 and main memory 136. I/O peripheral devices often include speaker systems 152, graphics devices 154, and other I/O devices 144 such as display monitors, keyboards, mouse-type input devices, floppy and hard disk drives, DVD drives, CD-ROM drives, and printers. Many computer systems also include network capability, terminal devices, modems, televisions, sound devices, voice recognition devices, electronic pen devices, and mass storage devices such as tape drives. The number of devices available to add to personal computer systems continues to grow, however computer system 130 may include fewer components than shown in FIG. 1 and described herein. The peripheral devices usually communicate with processor 132 over one or more buses 134, 156, 158, with the buses communicating with each other through the use of one or more bridges 160, 162.

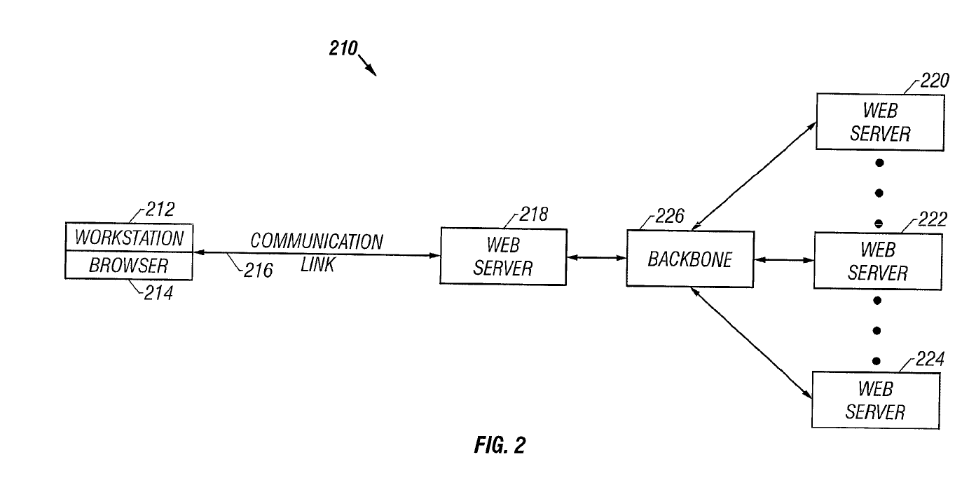

Accurately rating a supplier requires comment from various parts of a manufacturer's organization. The method gathers evaluation from a team leader, team members and the supplier over a network of computer systems, such as the Internet. An example of a typical network connection is shown in FIG. 2. A user, (such as a team member, team leader or supplier) that wishes to provide information via a network connection typically has a computer workstation 212, also referred to as “the user workstation”, that executes an application program known as a web browser 214. Workstation 212 establishes a communication link 216 with web server 218 such as a dial-up wired connection with a modem, a direct link such as a T1 or ISDN line, a wireless connection through a cellular or satellite network. When the user enters a request for information by entering commands in web browser 214, workstation 212 sends a request for information, such as a search for documents pertaining to a specified topic, to server 218. In the following description the internet is used as an example of a network, however this should not be taken to be limiting. However, the invention discloses a process applicable to a communication network such as internal corporate networks (intranets) and extensions of intranets to allow outside access (extranets) and other networks such as virtual private networks (VPN).

Using the Internet as an example, each server 218, 220, 222, 224 has a known address which the user must supply to the web browser 214 in order to connect to the appropriate web server 218, 220, 222, or 224. If the information is available on the user's web server 218, a central link such as backbone 226 allows web servers 218, 220, 222, 224 to communicate with one another to supply the requested information.

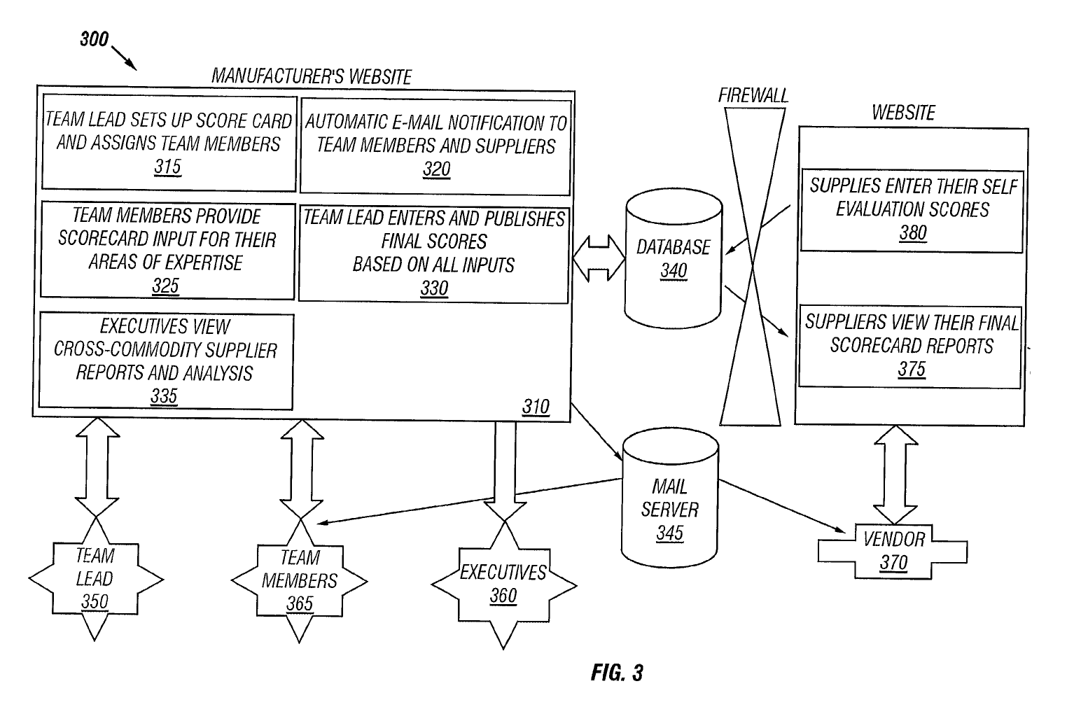

The web server 218 services requests for the information and receives information from (or transmits information to) the user's workstation 212. Workstation 212 and/or web servers 216 are computer systems, such as computer system 130 as shown in FIG. 1. In an embodiment of the invention a team member, team leader or supplier may use a workstation, such as workstation 212 to transmit information to server 218 which stores the information. (See database 340 on FIG. 3, further described below.)

The process teaches rating suppliers according to the suppliers performance in several categories including: cost, quality, continuity of supply, technology, time to volume and field service. A scorecard can be used to organize comments and analysis from information provided by a team leader and team members. FIG. 3 represents the logical steps of the process of the invention. Team lead 350 orchestrates the activities of team members to evaluate a supplier. The process develops a score card as a tool to evaluate performance by supplier 370. The process begins when team leader 350 establishes a quarterly business objective for a supplier 370. While establishing a quarterly business objective team lead 350 will also select an appropriate score card 315 for a specific commodity supplied by supplier 370. Team lead 350 also selects individuals within the manufacturer's organization to be members of the team 365. One embodiment of the invention automatically notifies 320 the team members 365 using mail server 345 when input from the individual is expected.

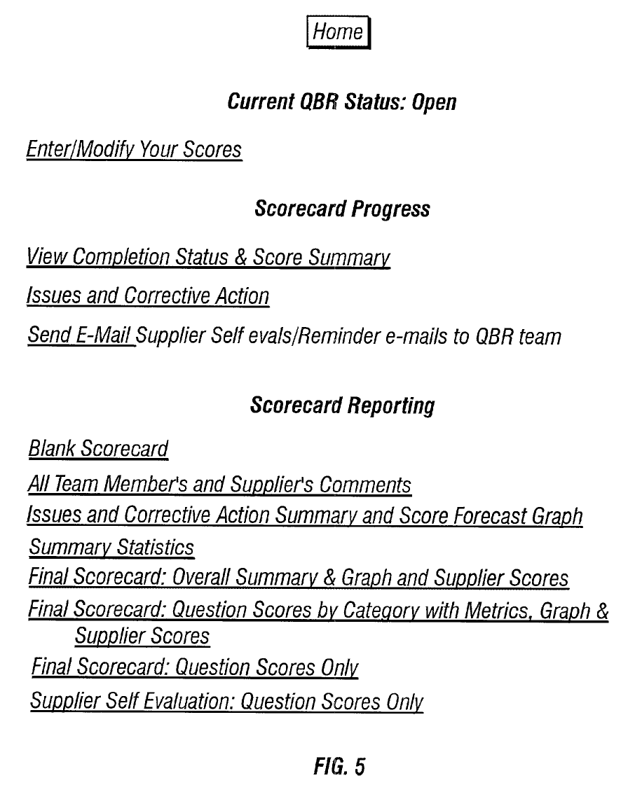

As represented in FIG. 3, team members 365 provide an evaluation of the supplier's performance including scores and comments. FIG. 5 is a plan view of a web page available to a team member 365 for recording the team member's contribution to the score card of a supplier. An embodiment of the invention provides a web page or pages tailored to accept input from team member 365 depending on the team member's role or function in the organization.

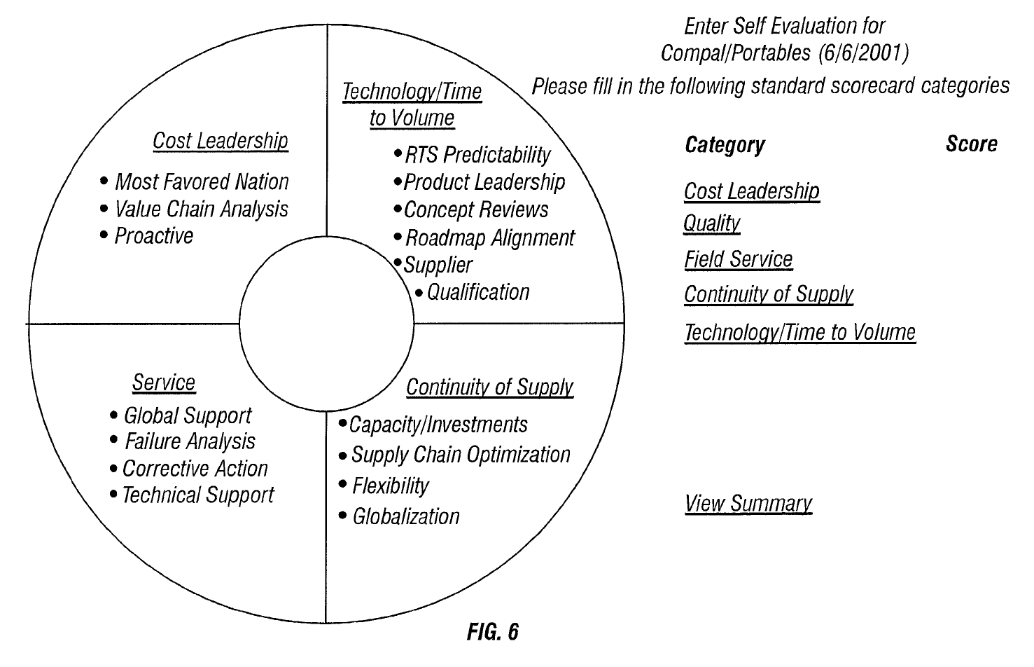

Referring again to FIG. 3, another embodiment of the invention automatically emails 320 suppliers when a score card is ready for input by the supplier. FIG. 6 is a plan view of a web page available to a supplier. A supplier enters self-assessment in one of 5 categories 380. When a score card is complete it is made available for review by the supplier 375. The completed score card includes the supplier's planned, or anticipated, score in comparison with their actual scores based on the team member's evaluation and team leader's analysis.

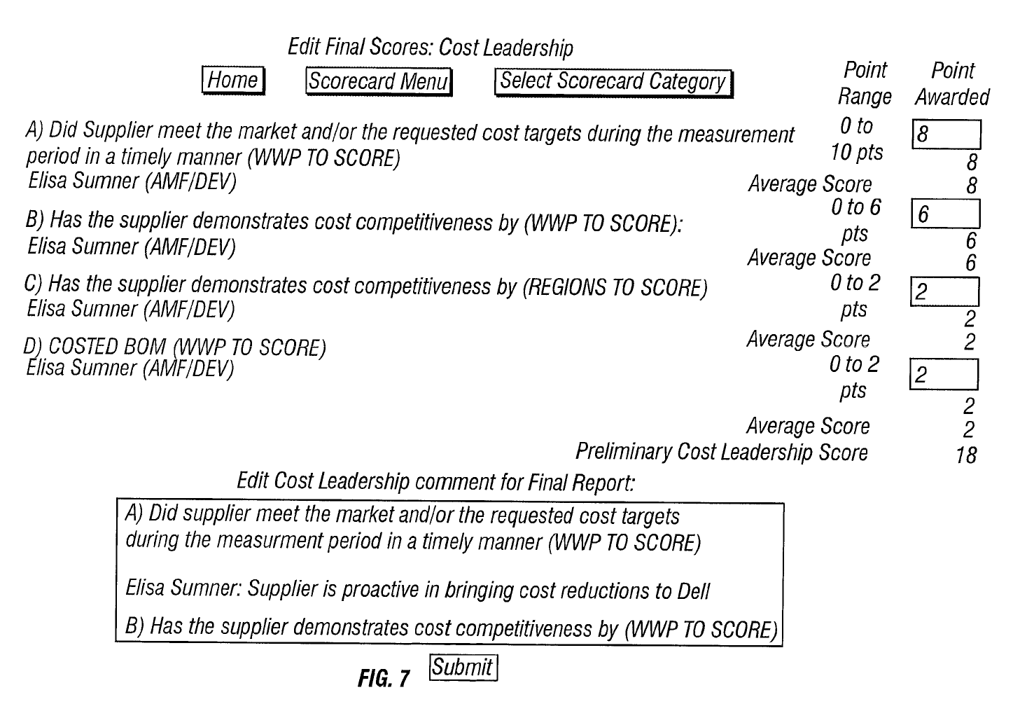

Referring again to FIG. 3, another feature of the process allows team lead 350 to review and consider 330 the evaluations of members of the team before finalizing the supplier's evaluation, or score card. FIG. 7 is a plan view of a web page accessed by a team leader after team members have entered their scores and the supplier has entered his anticipated score. The team leader can review the individual scores entered by members of a team. The team lead can use the average of the scores entered by the team member or assign more weight to the score provided by one team member. For example, a team member in a specific region or in a specific position, may have greater (or lessor) weight given to his score than a team member in another region or in another position. In the alternative, a team leader may over ride the average or weighted average of the individual team member's scores and replace the average score with a score he determines independently. In addition, a team leader can edit or delete comments by a team member.

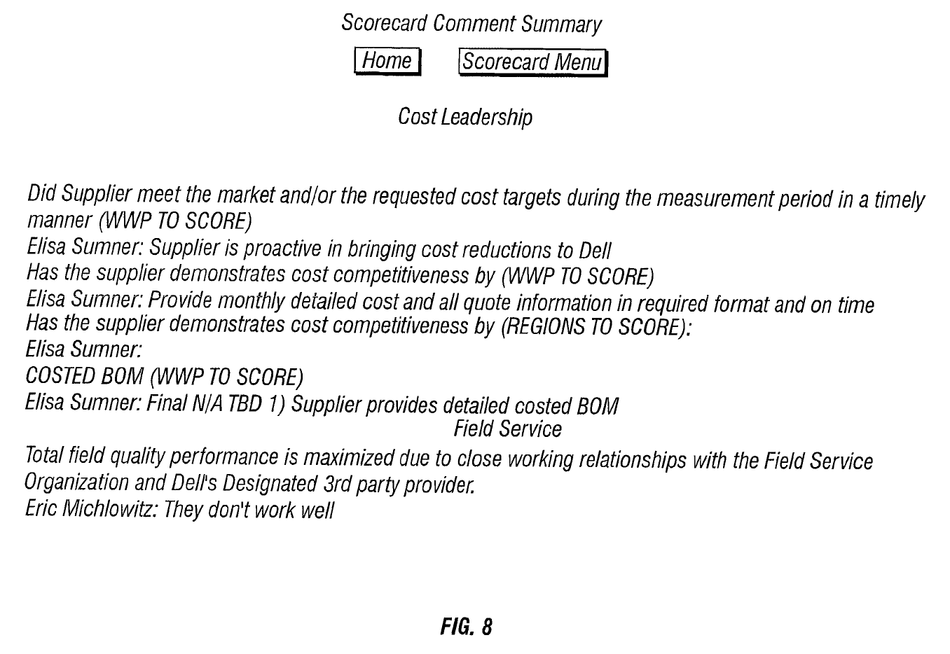

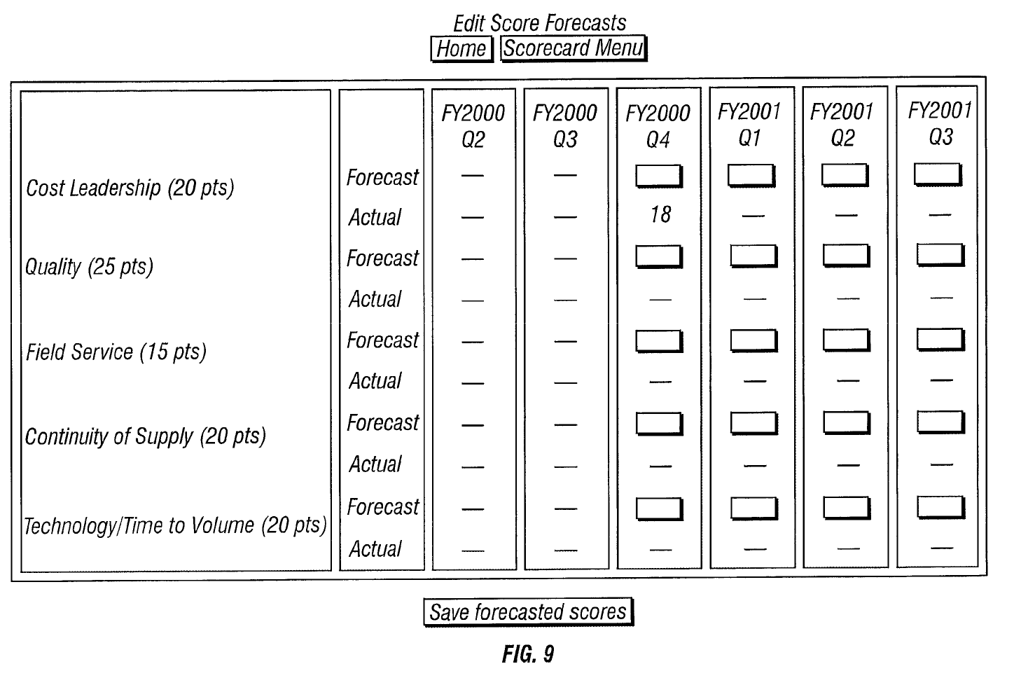

Referring again to FIG. 3, a feature of the process allows manufacturers to review a supplier's performance and plan improvements. FIG. 8 is a plan view of a web page available to team leads and other employees, including management, of a manufacturer. The manufacturers executives may use the score card comment summary to determine if a supplier has met performance targets for a specific period. Performance targets are divided into five categories: cost leadership, quality, field service, continuity of supply and time to volume. FIG. 9 is a plan view of a web page available to members of the team and the team leader. The web page represented by FIG. 9 to enter projected improvements in scores as projected by agreement between the manufacturer and supplier.

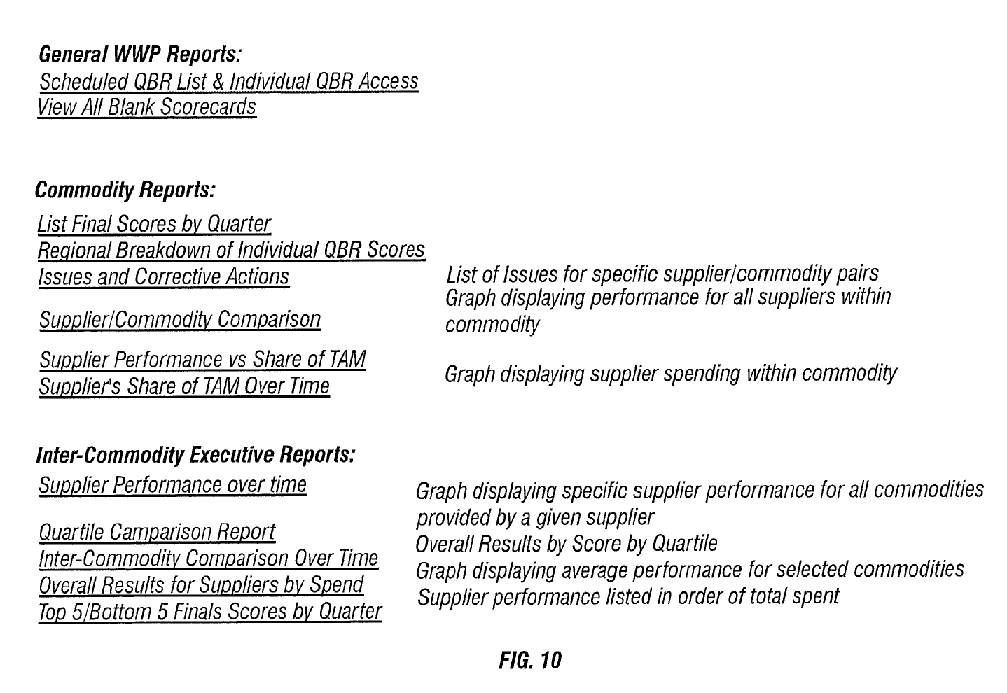

Referring again to FIG. 3, a feature of the process allows the manufacturer's executives 360 to view a report illustrating a suppliers performance for a given period 335. FIG. 10 is a plan view of a web page available to executives to determine how all suppliers supplying a specific commodity are performing. Referring again to FIG. 3, information regarding a suppliers performance for all commodities 335 is also available. After reviewing a supplier's performance, representatives of the manufacturer and representatives of the supplier can agree on a time line for improving a suppliers scores in each category, or in specific categories. These agreements, or forecasts are recorded for future reference. Future performance may be measured according to the performance agreed by the manufacturer and supplier.

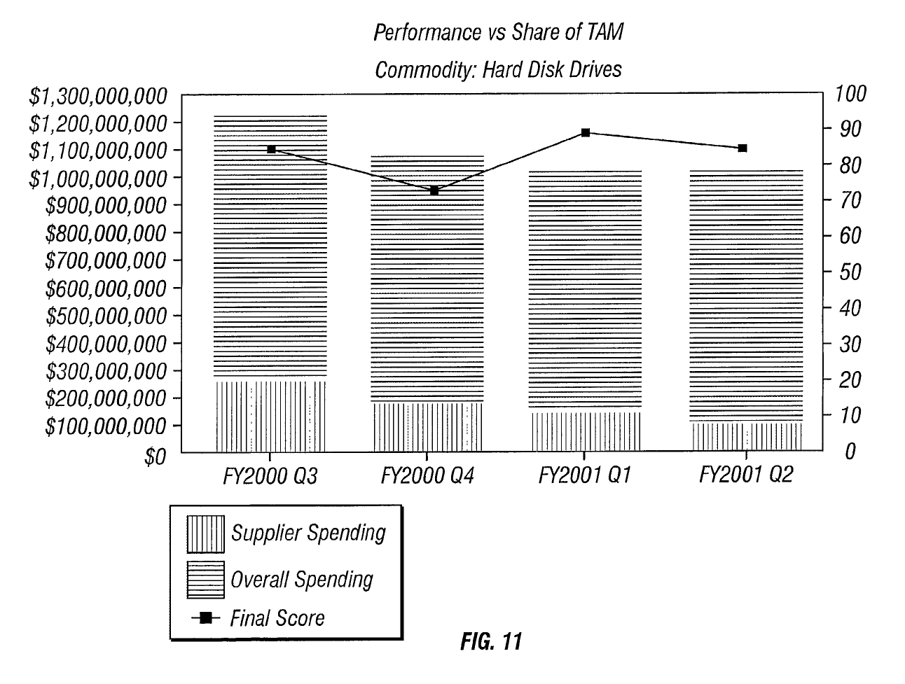

Referring again to FIG. 3, a feature of the process allows a manufacturer's executive 360 to view 335 the amount of funds spent with a specific supplier. FIG. 11 is a plan view of a web page which provides specific information regarding the supplier's performance. In this specific example, financial purchase order records are used to illustrate the amount of a total available market provided by a specific supplier. In the example show, a trend line is superimposed on the bar graph. The trend line illustrates whether the supplier's performance (as measured by the supplier's score card) and the amount of the total available market provided by the supplier are increasing or decreasing.

Referring again to FIG. 3, database 340 stores the information provided by team members, team leaders and in some cases by suppliers. After a scorecard is generated an executive 360 may request a report detailing the performance of a supplier 335.

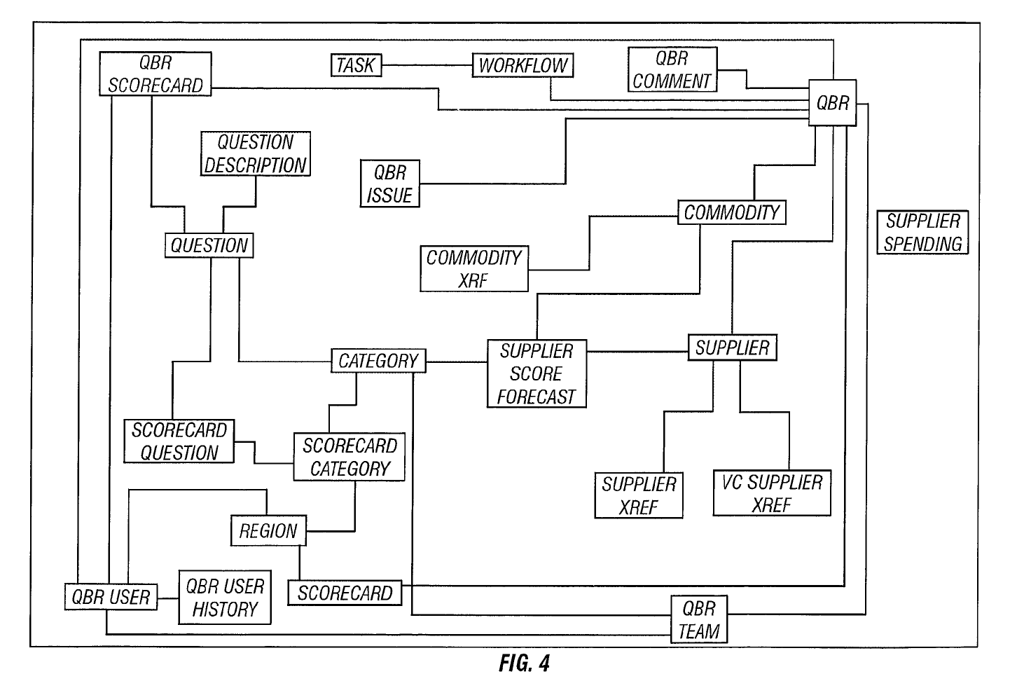

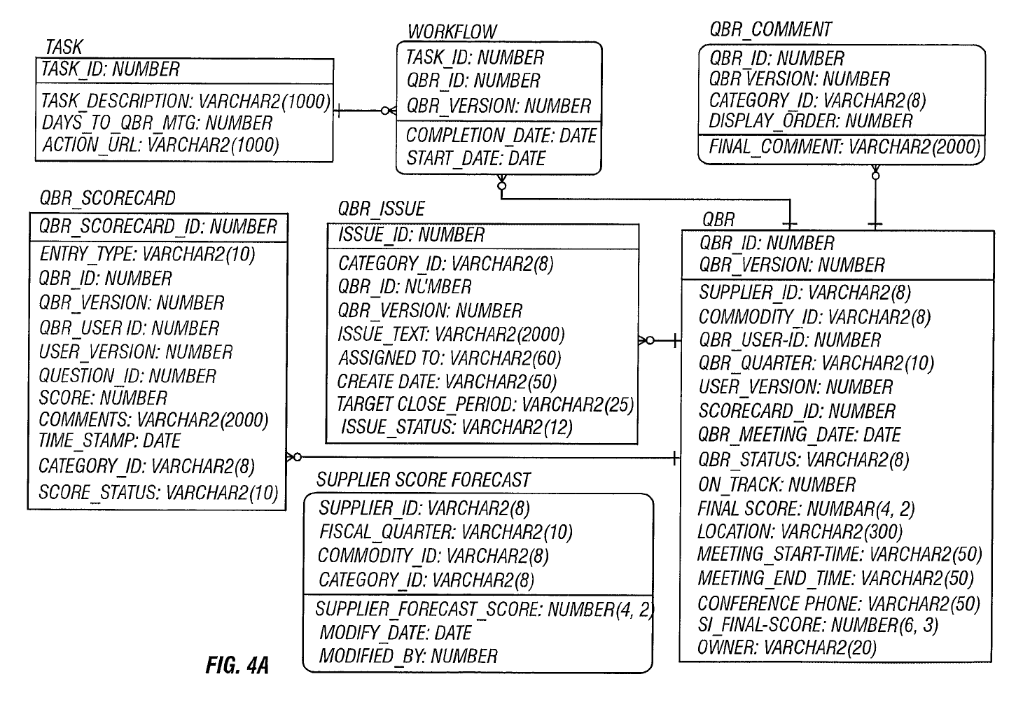

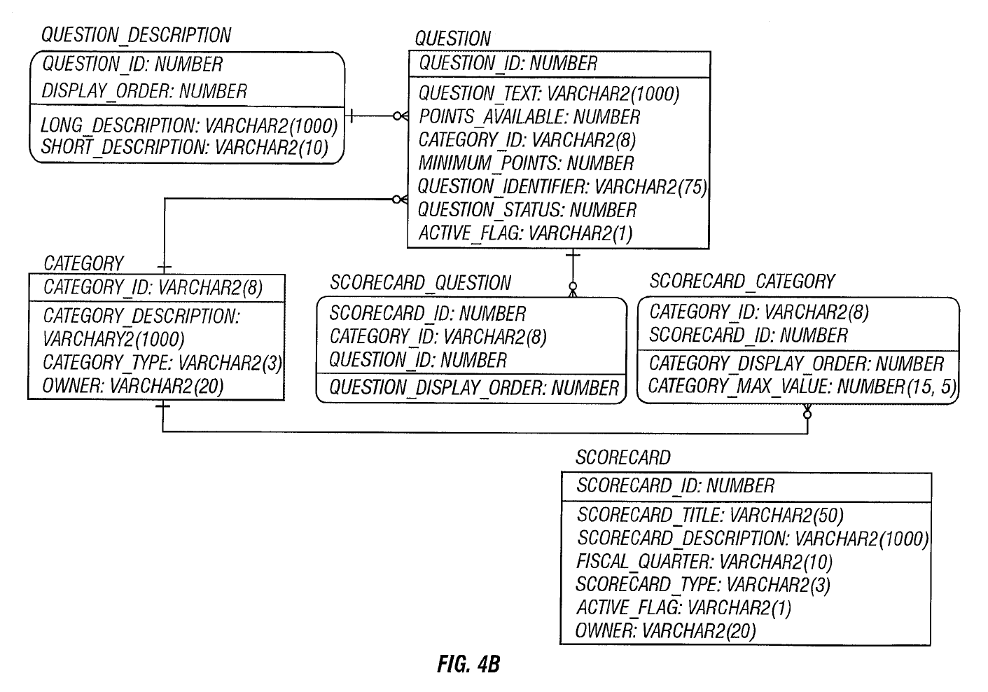

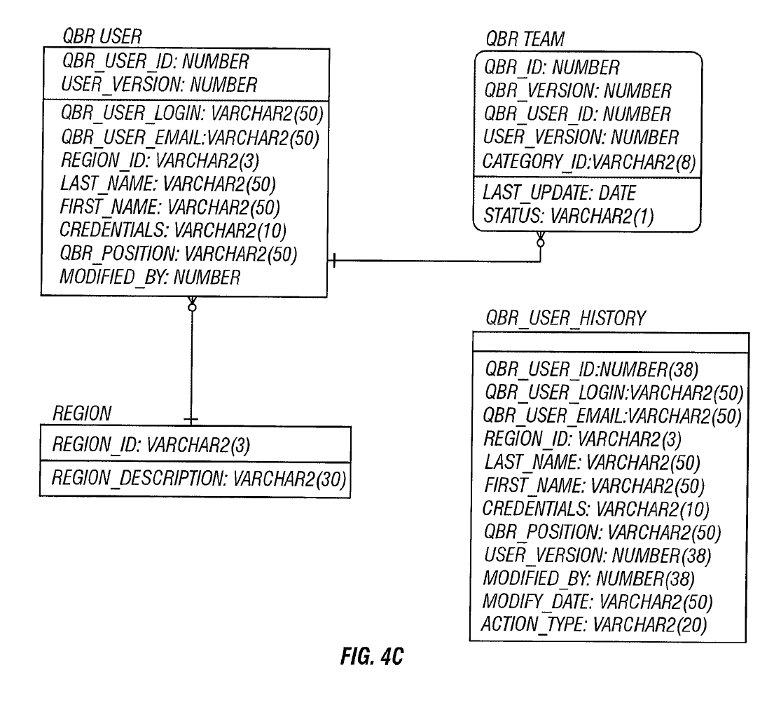

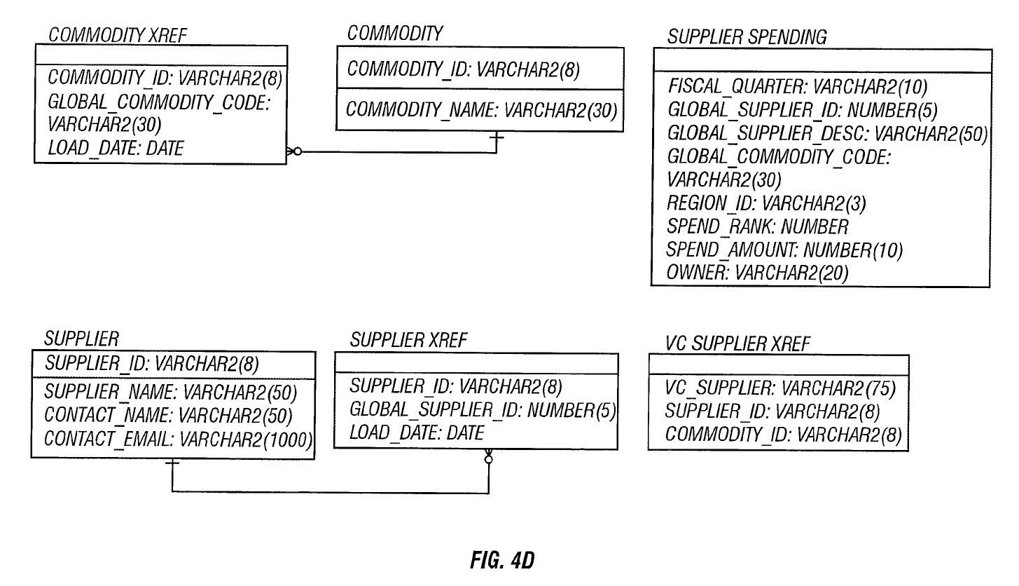

Refer now to FIG. 4 which shows the logical relationship between individual tables for storage of data supporting development of a completed score card. FIG. 4A shows the specific tables relating to individual, final and self-evaluation scores. In addition, comments are stored in these tables in addition to issues identified and score forecasts. FIG. 4B shows the tables storing information related to scorecard templates. Scorecards are made up of categories, which are made up of questions. FIG. 4C identifies user maintenance tables. User maintenance tables store access privileges for team members. User maintenance tables also store a log of changes made to all team member's access privileges. FIG. 4D shows reference tables which link the supplier with the manufacturer's internal intranet where the supplier may access forms, tools and applications specific to the manufacturer. Data table Commodity_Xref and Supplier_Xref are used to cross reference financial data contained in spending data for management reports. FIG. 4D also reflect tables which enable a supplier to view his performance evaluation.

One aspect of the process facilitates translating procurement objectives into a supplier scorecard. A feature of the invention can determine the best supplier in a class of suppliers. A class of suppliers are those suppliers who supply a specific commodity. A commodity is a purchased component. Using a computer system as an example then a hard drive, motherboard and a monitor would each be a component of the computer system and would each be a commodity.

An aspect of the process also measures total supply chain quality. Total supply chain quality measures quality of a manufactured product. In the example of a computer system total supply chain quality includes the frequency of failure of a computer system as the system is manufactured, before sale to a consumer. Total supply chain quality also includes the initial field incident rate (IFR). The initial field incident rate includes failures within the first 30 days of a system's operation.

Another aspect of the process allows a manufacturer to compare cost leadership between suppliers. The manufacturer can determine if he is receiving the best cost for components of the same form, fit and function supplied by different suppliers. An aspect of the process also determines how well a supplier has met supply expectations of the manufacturer. Features of the process allow recording and evaluation of the number of times (frequency) that a supplier delayed supplying promised goods or otherwise created a supply disruption. In the alternative, the process also allows the manufacturer to monitor the length of time (duration) of supply disruptions caused by a specific supplier.

An aspect of the process records and measures the supplier's service performance. Service performance is a measure of a supplier's support for a manufacturer's service and warranty activities. If a supplier supplies a component and an individual component fails, the manufacturer will contact the supplier and ask for information or analysis of the failure. An aspect of the process tracks this service performance of individual suppliers. A supplier quickly making an engineering change to a product will receive a higher score for service performance rather than a supplier who does not respond to this request for information.

A feature of the process allows the manufacturer to review a supplier's past performance and communicate areas of needed improvement, or strategy, to the supplier. A manufacturer may make available a supplier's final score card for the supplier's review. The score card can be published on a system or network such as the internet. A manufacturer can directly, in a meeting or otherwise, communicate needed areas of improvement to a supplier. A completed score card available to the supplier allows the manufacturer and supplier to plan performance improvements and objectives. A gap analysis also allows a supplier and manufacturer to identify specific deficiencies in a supplier's performance, facilitating improvements and plans for improvements.

A feature of the process allows a manufacturer, or a manufacturer and a supplier to evaluate a supplier's performance with respect to other supplier's the same class. Evaluating a supplier's performance with respect to other suppliers in the same class provides motivation and incentive for a supplier to increase his performance thus decreasing costs and increasing reliability. Similarly, a feature of the process allows a manufacturer and a supplier to reach agreement on future performance targets. Future performance targets can be used to measure a suppliers meeting a manufacturers goals, such as decreased price, improved performance or improved reliability. Finally, a feature of the process allows critical features of the suppliers historical performance to be highlighted or otherwise emphasized. Emphasizing features of a suppliers historical performance allows a manufacturer to fully utilize a supplier with stronger abilities.

As described above reviewing a suppliers past and current performance allows a manufacturer to provide new product opportunities to a supplier. A manufacturer may seek bids on new projects for suppliers with proven past performance. Similarly, a manufacturer may utilize the historical information to align himself (the manufacturer) more closely with preferred suppliers or suppliers with proven performance, dependability or reliability. The historical information can be used to demonstrate to a supplier areas in which his company can improve, to assist the manufacturer to create a more reliable product and to facilitate economies of scale between the manufacturer and supplier.

While particular embodiments of the present invention have been shown and described, it will be obvious to those skilled in the art that, based upon the teachings herein, changes and modifications may be made without departing from this invention and its broader aspects, and therefore, the appended claims are to encompass within their scope all such changes and modifications as are within the true spirit and scope of this invention. Furthermore, it is to be understood that the invention is solely defined by the appended claims.

What is claimed is:

1. A method for evaluating supplier performance, comprising:
receiving a first evaluation of the supplier submitted electronically by a team member of a customer of the supplier;
receiving a second evaluation of the supplier submitted electronically by a team leader of the customer;
receiving a third evaluation of the supplier submitted electronically by the supplier; and
generating an indicia of a supplier's performance based on the first, second and third evaluation.

2. The method as recited in claim 1, further comprising:
generating and providing a report representing the indicia of the supplier's performance.

3. The method as recited in claim 1, further comprising:
providing access for the supplier to view electronically the indicia of the supplier's performance.

4. The method as recited in claim 1, further comprising:
providing access for the supplier to view electronically an indicia of the performance of all suppliers of a class of components.

5. The method as recited in claim 1, further comprising:
communicating an indicia of the performance of the supplier to members of a manufacturing organization.

6. The method as recited in claim 1, further comprising:
analyzing the performance of a supplier based on the performance of the best supplier in the class of suppliers.

7. The method as recited in claim 1, further comprising:
analyzing the performance of a supplier based on improvements required by a manufacturer.

8. The method as recited in claim 1, further comprising:
agreeing to future performance targets.

9. A system for evaluating a supplier, comprising;
a computer system, the computer system including a computer program product encoded in computer readable media, the computer program operable to:
receive a first evaluation of a supplier submitted by a team member of a customer of the supplier;
receive a second evaluation of the supplier submitted by a team leader of the customer;
receive a third evaluation of the supplier submitted by the supplier; and
generate an indicia of the supplier's performance based on the first, second and third evaluation.

10. The system as recited in claim 9, wherein the computer system is configured to communicate over a network and to receive evaluations submitted from a second computer system across the network.

11. The system as recited in claim 10, wherein the network is a public global communication network.

12. A method for evaluating supplier performance, comprising:
receiving a first evaluation of the supplier submitted electronically by a team member of a customer of the supplier;
receiving a second evaluation of the supplier submitted electronically by a team leader of a customer of the supplier; and
generating an indicia of the supplier's performance based upon the first and second evaluation.

13. The method as recited in claim 12, further comprising:
generating and providing a report representing the indicia of the supplier's performance.

14. A computer program product encoded in computer readable media, the computer program product comprising:
instructions, executable on a computer system, configured to:
receive a first evaluation of a supplier submitted electronically by a team member of a customer of the vendor;
receive a second evaluation of a supplier submitted electronically by a team leader of the customer;
receive a third evaluation of the vendor submitted electronically by the vendor; and
generate an indicia of the vendor's performance based upon the first, second and third evaluations.

15. A system for evaluating a supplier, comprising:
a computer system, the computer system including a data storage device, the data storage device storing data for a supplier performance among suppliers supplying a class of components, comprising:
data representing quality of components supplied by each supplier;
data representing cost of components supplied by each supplier;
data representing availability of the components from each supplier;
data representing service performance of each supplier; and
data representing a top performing vendor among the suppliers supplying the class of components.

16. The system as recited in claim 15, further comprising:
a server, wherein the computer system and the server are configured to communicate over a network and receive evaluations submitted from a second computer system across the network.

17. A method of evaluating the performance of a supplier, the performance of the supplier determined from at least one of a group, comprising:
determining a best supplier in the class of suppliers, wherein the class of suppliers are those suppliers supplying a component to a manufacturer.

18. The method as recited in claim 17, further comprising:
determining an indicia of quality of a component supplied by the supplier to the manufacturer.

19. The method as recited in claim 17, further comprising:
determining a cost of a component provider by a supplier.

20. The method as recited in claim 17, further comprising:
determining an indicia of availability of components supplied by a supplier.

21. A method of evaluating the performance of a supplier, the performance of the supplier determined from at least one of a group consisting of:
receiving a first evaluation of the supplier submitted electronically by a team member of a customer of the supplier;
receiving a second evaluation of the supplier submitted electronically by a team leader of the customer; and
generating an indicia of a supplier's performance based on the first and second evaluation.

22. The method as recited in claim 21, further comprising:
communicating an indicia of the performance of the supplier to members of a manufacturing organization.
